(19) United States
(12) Patent Application Publication
(10) Pub. No.: US 2006/0200427 A1
(43) Pub. Date: Sep. 7, 2006

(54) Systems and methods for securing transactions with biometric information

(76) Inventors: Robert A. Morrison, Sedalia, CO (US); Ronald N. Baird, Sedalia, CO (US)

Correspondence Address: MARSH, FISCHMANN & BREYFOGLE LLP, 3151 SOUTH VAUGHN WAY, SUITE 411, AURORA, CO, 80014, US

(21) Appl. No.: 11/194,514

(22) Filed: Aug. 1, 2005

Related U.S. Application Data
(60) Provisional application No. 60/657,375, filed on Mar. 1, 2005.

(51) Int. Cl. G06Q 99/00

(52) U.S. Cl. 705/67

(57) ABSTRACT

A system that performs a transaction includes a mobile handset that has a biometric sensor. The biometric sensor detects a biometric from a user of the mobile handset. The mobile handset is associated with an account number. The system also includes an authentication processor configured to receive an authentication code from the mobile handset. The authentication processor uses the authentication code to authenticate the user and the user is granted access to an account corresponding to the account number when the user is authenticated by the authentication processor. The mobile handset may include a code generator that generates the authentication code. For example, the code may be generated from stored biometric information, a detected biometric, the account number, a phone number associated with the mobile handset, a serial number of the mobile handset, or a combination thereof. In one embodiment, the account number is the phone number.

### CROSS REFERENCE TO RELATED APPLICATIONS

This patent application claims priority to and thus the benefit of an earlier filing date from U.S. Provisional Patent Application No. 60/657,375 (filed Mar. 1, 2005; hereinafter the “'375 application”), the entire contents of which are hereby incorporated by reference.

### BACKGROUND

1. Field of the Invention

The invention generally relates to performing a transaction, such as an exchange of money for goods and/or services, and more specifically to performing a transaction using a mobile handset, such as a cell phone.

2. Discussion of the Related Art

Various manners for performing transactions have often relied on the inherent authentication of a buyer's intimate knowledge of certain information. For example, a buyer may initiate a purchase using a telephone or another communication technique, such as the Internet. When the buyer authorizes the purchase, the buyer may submit through the chosen communication technique an account number, such as a credit card number. Once a seller receives the credit card number, the seller may perform the transaction by contacting the financial institution that maintains the credit account associated with the credit card number. The seller may convey the credit card number to the financial institution and, based on that credit card number, the financial institution may transfer monetary funds to the seller (e.g., the seller's account). Once the seller concludes that the monetary funds have been transferred, the seller may complete the transaction between the buyer and the seller.

As mentioned, the authentication of the buyer is substantially dependent upon the buyer's possession of the credit card number. If the buyer does not have the credit card information, the buyer may be precluded from making a purchase. Authentication may also rely upon the financial institution. For example, the financial institution may blindly authenticate a buyer by authorizing a transaction as long as the card is deemed “active” (e.g. not canceled by the buyer). In either case, the authentication of a buyer is only moderately effective particularly in view of recent identity thefts from major financial institutions because, among other reasons, the credit card number may be continuously exposed.

### SUMMARY OF THE INVENTION

Various systems and methods for performing a transaction using the mobile handset are shown and described herein. In one embodiment, a system that performs a transaction includes a mobile handset that has a biometric sensor. The biometric sensor detects a biometric from a user of the mobile handset. The mobile handset is associated with an account number. The system also includes an authentication processor configured to receive an authentication code from the mobile handset. The authentication processor uses the authentication code to authenticate the user and the user is granted access to an account corresponding to the account number when the user is authenticated by the authentication processor.

The account number may be a phone number. For example, cell phones are typically associated with a unique phone number so that phone calls are correctly directed to intended users. Since these phone numbers are unique, a financial entity may be configured to associate an account number to a particular phone number of a mobile handset thereby allowing a mobile handset to access a user's account.

The mobile handset may include a radio frequency interface that transmits the authentication code to the authentication processor. For example, the mobile handset may be configured to communicate via the radio frequency interface using a signaling technique such as Global System for Mobile communications (“GSM”), Code Division Multiple Access (“CDMA”), Wideband Code Division Multiple Access (“WCDMA”), Time Division Multiple Access (“TDMA”), Global Positioning System (“GPS”), Frequency Division Multiple Access (“FDMA”), or a combination thereof.

The mobile handset may include a storage element that stores biometric information of the user for comparison to a detected biometric. The mobile handset may also include a comparator that compares stored biometric information to the detected biometric to generate an authentication indicator. Additionally, the mobile handset may include a code generator that generates the authentication code from the authentication indicator, the stored biometric information, the detected biometric, the account number, a phone number associated with the mobile handset, a serial number of the mobile handset, or a combination thereof.

The authentication processor may include an interface that receives the authentication code from the mobile handset. For example, the interface may be a telephony interface, an Internet connection, or a combination thereof. The authentication processor may further include a comparator that compares a received authentication code to a stored authentication code to authenticate the user. Additionally, the authentication processor may include an authenticator communicatively coupled to the comparator to generate an authentication indicator when the user is authenticated by the comparator.

The system may include a first processing entity communicatively coupled to the authentication processor to grant access to the account when the user is authenticated by the authentication processor. Additionally, the system may include a second processing entity communicatively coupled to the first processing entity, wherein the first processing entity transfers money from the account to the second processing entity to perform the transaction for the user. The system may also include a transaction processor communicatively coupled to the mobile handset to transfer transaction information to the mobile handset. The transaction processor may be communicatively coupled to the second processing entity, wherein the second processing entity transfers a transaction indicator to the transaction processor to indicate transaction performance. Alternatively, the transaction processor may be communicatively coupled to the first processing entity, wherein the first processing entity transfers a transaction indicator to the transaction processor to indicate transaction performance. The transaction may be a financial transaction, a property transaction, or a combination thereof, as described hereinbelow.

In another embodiment, a method of performing a transaction includes registering a biometric with a mobile handset to generate a code, transferring the code from the mobile handset to an authentication processor to authenticate the biometric, and granting access to an account when the biometric is authenticated to perform a transaction. Registering a biometric may include detecting the biometric with a sensor configured with the mobile handset, comparing the biometric to stored biometric information, and generating the code when the biometric corresponds to the stored biometric information. Generating the code may include configuring the code from a phone number associated with the mobile handset, a serial number of the mobile handset, and detected biometric information, the stored biometric information, an account number, or a combination thereof.

Transferring the code may include configuring a radio frequency telephony signal with the code. The method may also include receiving the code with an interface of the authentication processor. Additionally, the method may include retrieving a stored authentication code for comparison to a received code. For example, the method may also include generating an authentication indicator based on the comparison of the stored authentication code to the received code and transferring the authentication indicator to a financial entity. Granting access to an account may thereby include granting access to the account based on the authentication indicator.

In yet another embodiment, a system for performing a property transaction includes a mobile handset that includes a biometric sensor, wherein the biometric sensor compares a detected biometric to stored biometric information to generate an authentication code and an authentication processor configured to receive the authentication code from the mobile handset and compare the authentication code to a stored authentication code to grant access to a processing entity and perform a property transaction. The authentication processor may include an interface configured to receive the authentication code from the mobile handset. As such, the mobile handset may include an interface that communicatively couples to the authentication processor to transfer the authentication code. The interface may be a cellular telephony interface.

The authentication processor may also include a comparator that compares the authentication code to the stored authentication code to determine authenticity of a user of the mobile handset. The authentication processor may further include an authenticator communicatively coupled to the comparator to generate an authentication indicator when the user of the mobile handset is authenticated by the comparator. The authentication indicator may include a phone number associated with the mobile handset.

In another embodiment, a mobile telephony handset includes a transceiver that communicatively links via a phone number, a sensor that receives first biometric information, and a processor that processes the first biometric information to perform a transaction using the phone number. The mobile telephony handset may also include a storage element that stores second biometric information.

The mobile telephony handset may further include a comparator that compares the first biometric information to the second biometric information to authenticate a user such that the user may perform the transaction using the phone number. Additionally, the mobile telephony handset may include a communication interface that communicatively couples the mobile telephony handset to a transaction processor, wherein the transaction processor determines authorization of the transaction based on the phone number. The communication interface provides for communications to the transaction processor via radio frequency, Internet, Ethernet, infrared, serial cable, parallel cable, or FireWire.

Another embodiment of the invention includes a communication device having a sensor that receives biometric information, a processor that processes received biometric information to generate authentication information for use in a transaction, and a transmitter that transfers the authentication information for external transaction authorization. The device may further include a comparator that compares stored biometric information to received biometric information. Accordingly, the device may include a storage element that stores stored biometric information.

The device may include a communication interface coupled to the transmitter that communicatively couples the device to a transaction processor. The transaction processor may be associated with a financial institution or a seller.

The authentication information may include a code. That code may or may not include biometric information of the user, subject to design choice. In one instance, the biometric information is not transferred for external transaction authorization. For example, the authentication information may be devoid of the biometric information. The code may be synchronizeable based on a plurality of sensed biometric inputs, as described in the '375 application.

The authentication information may include a phone number. As such, the communication device may be a mobile telephony handset. Such a mobile telephony handset may be a cellular telephone that uses GSM, CDMA, FDMA, TDMA, or combinations thereof.

In one embodiment, a method for performing a transaction includes steps of registering a biometric with a portable communication device to convert the biometric to electronic biometric information, and with the portable communication device processing the electronic biometric information to authenticate a user generating authentication information for a transaction when the user is authenticated.

The step of registering a biometric may include a step of providing the biometric to an electronic sensor, wherein the biometric is selected from a group consisting of DNA, a follicle pattern, a veinal pattern, an arterial pattern, a cardio pattern, a fingerprint, a voice pattern, an aural pattern, a retinal pattern, a corneal pattern, and a skin pattern. The method may further include a step of electronically sensing the biometric to convert the biometric to the electronic biometric information.

Processing the electronic biometric information may include a step of comparing the electronic biometric information to biometric information stored with the portable communication device to determine whether the electronic biometric information corresponds to the biometric information stored with the portable communication device. The step of processing the electronic biometric information may further include a step of generating a first indicator when the electronic biometric information corresponds to the biometric information stored with the portable communication device. For example, generating the authentication information may include a step of formatting a phone number within the authentication information based on the first indicator. The authentication information may be devoid of the electronic biometric information and the biometric information stored with the portable communication device. Processing the electronic biometric information may further include a step of generating a second indicator when the electronic biometric information does not correspond to the biometric information stored with the portable communication device.

The method may further include a step of using the second indicator to deny the transaction. Additionally, the method may include a step of transferring the authentication information to a transaction processor for authorization of the transaction. For example, the step of transferring the authentication information to a transaction processor may include a step of communicatively coupling the portable communication device to the transaction processor via an interface that supports radio frequency communication, Internet communication, Ethernet communication, infrared communication, serial cable communication, parallel cable communication, or FireWire communication.

In yet another embodiment, a method of securing a transaction includes steps of authenticating a transaction party based on a biometric, generating transaction information based on an authentication of the transaction party, and transferring the transaction information to an external transaction processor. The method may further include a step of registering the biometric with a sensor that converts the biometric into electronic biometric information. For example, the step of authenticating a transaction party may include a step of comparing electronic biometric information to stored biometric information to authenticate the transaction party. Based on a comparison of the electronic biometric information to the stored biometric information, the method may include a step of generating authentication information for use in generating the transaction information. The authentication information may be devoid of biometric information.

Generating a transaction information may include a step of formatting the transaction information with a phone number for use by the external transaction processor in authorizing the transaction. Generating the transaction information may include a step of configuring the transaction information into a format transferable by radio frequency, Internet, Ethernet, infrared, serial cable, parallel cable, or FireWire.

In one embodiment, a method for performing a transaction includes entering a code to a mobile handset using a keypad configured with the handset, transferring the code from the mobile handset to an authentication processor to authenticate the code, and granting access to an account when the code is authenticated to perform a transaction.

### BRIEF DESCRIPTION OF THE DRAWINGS

FIG. 1 is a block diagram illustrating a system for performing transactions with a mobile handset, in one exemplary embodiment of the invention.

FIG. 2 is a block diagram of an authentication processor used in the system of FIG. 1, in one exemplary embodiment of the invention.

FIG. 3 illustrates a mobile handset, in one exemplary embodiment of the invention.

FIG. 4 is a block diagram of another system for performing transactions, in one exemplary embodiment of the invention.

FIG. 5 is a block diagram of yet another system for performing transactions, in one exemplary embodiment of the invention.

FIG. 6 is a flowchart illustrating a process for performing transactions, in one exemplary embodiment of the invention.

FIG. 7 is another flowchart illustrating a process for performing transactions, in one exemplary embodiment of the invention.

FIG. 8 is yet another flowchart illustrating a process for performing transactions, in one exemplary embodiment in the invention.

### DETAILED DESCRIPTION OF THE DRAWINGS

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope and spirit of the invention as defined by the claims.

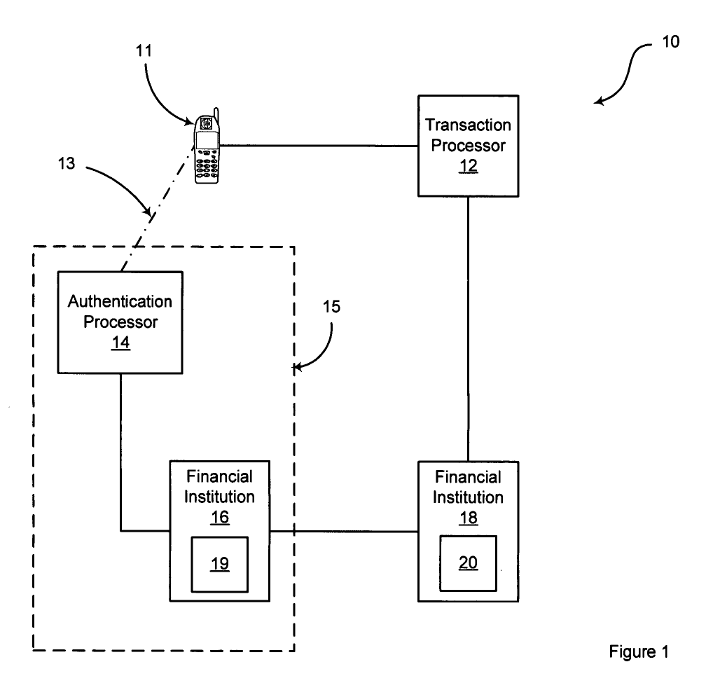

Turning now to the drawings, FIG. 1 is a block diagram illustrating system 10 which is operable to perform transactions with mobile handset 11. In this embodiment, system 10 may operate to transact money and/or property with transaction processor 12 via mobile handset 11. For example, mobile handset 11 may be configured with an interface that communicatively couples to transaction processor 12 to receive a transaction description (e.g., price, goods, services, etc.). Processing of the transaction description initiates with the authentication of a user of the mobile handset. Once the user is authenticated, mobile handset 11 may transfer the transaction description to financial institution 16 so that the user may access account 19 (i.e., the user's account) to perform the transaction. In one embodiment, mobile handset 11 is a cell phone and the account number associated with account 19 is the phone number for the mobile handset.

Mobile handset 11 may use typical means of cellular telephony, such as GSM, CDMA, WCDMA, FTM, TDM, or combinations thereof. Other means of telephony may include RF communications, such as GPS. For example, mobile handset 11 may include a radiofrequency transceiver operable to employ such communication techniques to interface communications between authentication processor 14 and a mobile handset. Mobile handset 11 may, therefore, be operable to communicate to authentication processor 14 via antenna 34 and via communication link 13 as implemented by the cellular telephony described herein. In communicating with authentication processor 14, mobile handset 11 may transmit a code to authentication processor 14 to authenticate a user of the mobile handset so that access may be granted to account 19 maintained by financial institution 16.

Mobile handset 11 may configure the code for user authentication in a variety of manners. One exemplary manner includes using a biometric sensor that is configured with mobile handset 11 to detect the biometric of a user and compare the biometric to biometric information stored with mobile handset 11. If the detected biometric corresponds to the stored biometric information, mobile handset 11 may generate a code for use by authentication processor 14 to either authenticate the user or grant immediate access to account 19. For example, once mobile handset 11 generates a code and transfers it to authentication processor 14, authentication processor 14 may receive the code and compare it to another code stored with the authentication processor. If the received code corresponds to the stored code, authentication processor 14 may generate an authentication indicator for financial institution 16 to grant access to account 19. Alternatively, based on a valid comparison of the received code to the stored code, authentication processor 14 may grant direct access to account 19. As such, authentication processor 14 and financial institution 16 may be located or at least communicatively linked as a single entity 15. In either case, mobile handset 11 may generate the code based on, for example, a serial number of the mobile handset, a phone number of the mobile handset, the stored biometric information, and/or various encryption standards, such as the Advanced Encryption Standard (“AES”).

In an alternative embodiment, mobile handset 11 may include a biometric sensor that detects the biometric of the user and converts the detected biometric to digital biometric information which may be used by authentication processor 14 to authenticate the user. For example, authentication processor 14 may receive encoded biometric information from mobile handset 11 and decode the biometric information for comparison to biometric information stored with authentication processor 14. The digital biometric information may be configured with or encoded by information such as a serial number of the mobile handset, a phone number of the mobile handset and/or various encryption standards (e.g., AES).

In either of the above-mentioned embodiments, the sensor may be configured to detect a variety of user biometrics. For example, the sensor may be configured to detect retinal information, fingerprint information, ocular information, DNA, veinal information, arterial information, voice information, and/or pulmonary information.

In yet another embodiment, mobile handset 11 may be operable to generate a code based on a user's entry with a keypad configured with the mobile handset. For example, a user may enter a series of numbers using the keypad of mobile handset 11 when a transaction is desired. Mobile handset 11 may use the series of numbers to either generate a code for use by authentication processor 14 or transfer the series of numbers directly to authentication processor 14 for authentication of the user. In such an embodiment, authentication processor 11 may compare a received code to a code stored with the authentication processor to authenticate the user. If the received code corresponds to the stored code, authentication processor 14 may either grant direct access to account 19 or indicate the authentication of the user to financial institution 16 (e.g., via an authentication indicator).

Once the user is authenticated and granted access to account 19, financial institution 16 may review the transaction description and verify that account 19 is capable of fulfilling the transaction description (e.g., verify that sufficient monetary funds exist). If account 19 is capable of fulfilling the transaction description, financial institution 16 may perform the transaction with a financial institution of transaction processor 12. For example, transaction processor 12 may be associated with account 20 of financial institution 18. If account 19 has sufficient monetary funds to fulfill the transaction description, financial institution 16 will withdraw the necessary monetary funds and transfer them to account 20 of financial institution 18. Those skilled in the art, however, should readily recognize that the invention is not intended to be limited to a financial transaction between two financial institutions. For example, transaction processor 12 may be associated with the same financial institution as the user of mobile handset 11 i.e., financial institution 16). Accordingly, financial institution 16 may simply transfer funds from the mobile handset user's account (i.e., account 19) to the transaction processor's account (i.e., account 20).

Upon completion of the transaction (e.g., when monetary funds are transferred from account 19 to account 20), financial institution 18 may indicate to transaction processor 12 that the transaction is complete. Similarly, financial institution 16 may indicate to mobile handset 11 via authentication processor 14 that the transaction is complete. Mobile handset 11 may then process and retain information pertaining to the transaction so that the mobile handset user may have an accessible record of the transaction. For example, mobile handset 11 may maintain a sortable record of all transactions made by the user of mobile handset 11.

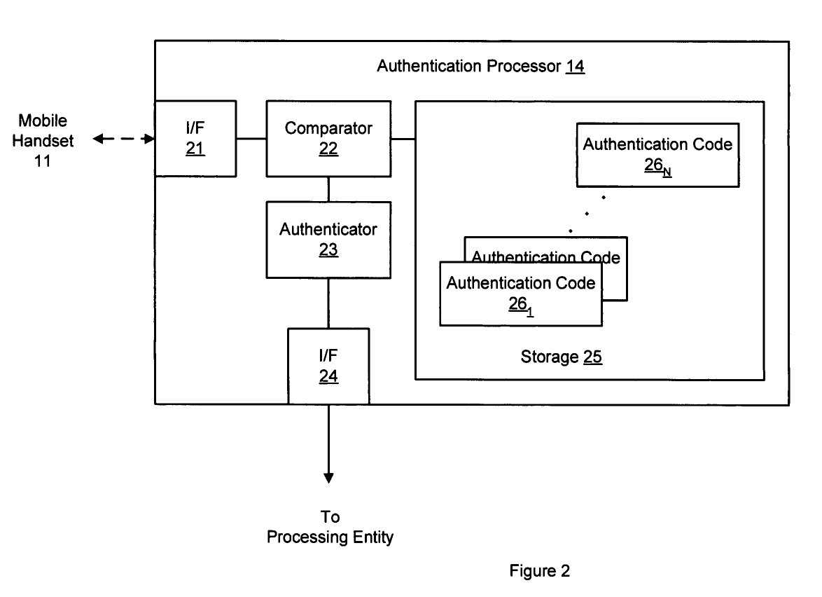

FIG. 2 is a block diagram of authentication processor 14 used in system 10 of FIG. 1. In this embodiment, authentication processor 14 includes interface 21 that is configured to receive an authentication code (e.g., the codes and/or biometric information described above in FIG. 1) such that the user of mobile handset 11 is granted access to an account (e.g., account 19 of FIG. 1) upon authentication of the user. Additionally, interface 21 may also receive the transaction description as provided by mobile handset 11. Authentication processor 14 may thereby transfer the transaction description to the financial institution upon authentication of the user of mobile handset 11.

In this embodiment, interface 21 is communicatively coupled to comparator 22 to convey a received authentication code to the comparator. Comparator 22 may compare the received authentication code to stored authentication codes 26_{1 . . . N} (wherein N is an integer greater than one). If the received authentication code corresponds to (e.g., matches) a stored authentication code 26, comparator 22 may authenticate the user of mobile handset 11.

Authentication processor 14 may include storage 25 that stores a plurality of pre-generated authentication codes 26_{1 . . . N}. Comparator 22 may compare the received authentication code to one or more of the pre-generated authentication codes 26_{1 . . . N} to verify that the received authentication code matches one of the pre-generated authentication codes within a predefined range. If the received authentication code matches the first compared pre-generated authentication code 26₁, comparator 22 simply authenticates the user of mobile handset 11 and conveys such to authenticator 23. If the received authentication code matches one of the other pre-generated authentication codes (e.g. codes 26_{2 . . . N}), comparator 22 may indicate to mobile handset 11 via interface 21 that a code generator of the mobile handset is not synchronous with the codes stored in storage 25. In such an embodiment, mobile handset 11 may then resynchronize its code generator to correspond with a code generator of authentication processor 14. Such synchronization is shown and described in the '375 application.

Upon authentication by comparator 22, authenticator 23 generates an authentication indicator for transfer to a processing entity via interface 24 (e.g., financial institution 16 of FIG. 1 or processing entity 41 described hereinbelow). For example, the authentication indicator may include a user's account number, phone number, or other information useful to a financial entity. A processing entity may use the authentication indicator to grant access to an account as described hereinabove since the user of mobile handset 11 has been authenticated. For example, the processing entity may grant a user access to the user's account because the processing entity is reasonably assured of the user's identity.

Those skilled in the art should readily recognize that authentication processor 14 is not intended to be limited to the configuration shown and described herein. For example, authentication processor 14 may be configured in other ways as a matter of design choice to implement the various aspects and features described herein. Additionally, those skilled in the art should readily recognize that authentication processor 14 may be configured from a variety of components that may include software, firmware, hardware, or combinations thereof. For example, interface 21 may be a standard hardware telephony interface configured for communicatively coupling to a Plain Old Telephone Service (“POTS”). Alternatively, interface 11 may be an Internet connection. Other components of authentication processor 14, such as comparator 22 and authenticator 23, may be implemented with a general-purpose processor operable to carry out the various aspects and features described herein when directed by software instructions. For example, software instructions may be configured to direct authentication processor 14 to access storage 25 and compare authentication codes 26 to an authentication code receive via interface 21. Examples of storage 25 include computer readable media, such as random access memory (“RAM”), disk drives, magnetic tapes, etc.

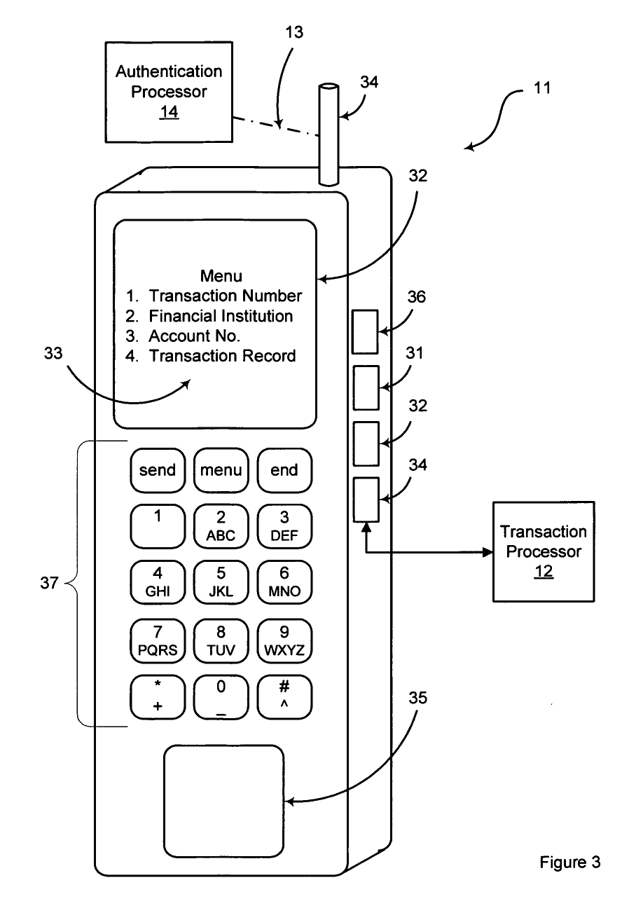

FIG. 3 illustrates an example of mobile handset 11. In this embodiment, mobile handset 11 is configured as a cell phone operable to convey data and/or voice via RF telephony techniques such as GSM, CDMA, WCDMA, FTM, TDM, or combinations thereof. For example, mobile handset 11 may communicate with authentication processor 14 via communication link 13. Communication link 13 may be representative of a telephony network that employs one or more of the above-mentioned RF telephony techniques.

Mobile handset 11 may include interface 34 to communicatively couple to transaction processor 12. For example, mobile handset 11 may receive a transaction description from transaction processor 12 via interface 34. Some examples that may be used to implement interface 34 include a serial interface, a parallel interface, a FireWire interface, an Ethernet interface, an infrared interface, an RF interface, or an optical interface. The invention, however, is not intended to be limited any of the exemplary interfaces described herein.

In one embodiment, mobile handset 11 includes biometric sensor 35 to detect a mobile handset user's biometric and authenticate the user. For example, biometric sensor 35 may detect a user's biometric for comparison to biometric information stored with mobile handset 11. Those skilled in the art are familiar with biometric sensors and their various configurations. Accordingly, mobile handset 11 may include storage element 36 that stores biometric information of the user. An example of storage element 36 may include nonvolatile RAM, or “NVRAM”, that is only accessed by comparator 31 such that the user's biometric information is not compromised.

Comparator 31 is operable to access storage element 36 to retrieve stored biometric information for comparison to the user's biometric as detected by biometric sensor 35. In one embodiment, comparator 31 generates an authentication indicator when the user's detected biometric corresponds to the stored biometric information within storage element 36. Comparator 31 may then transfer the authentication indicator to code generator 32 so that an authentication code may be generated. For example, code generator 32 may generate the code in accordance with the code generation described hereinabove (e.g., using a serial number of mobile handset 11, a phone number of mobile handset 11, the user's biometric information, encryption techniques, or various combinations thereof) in response to receiving an authentication indicator from comparator 31.

Alternatively, comparator 31 may compare the detected user biometric to the stored biometric information and transfer an authentication indicator directly to authentication processor 14 and/or financial institution 16. For example, the authentication indicator as generated by comparator 31 may be sufficient to authenticate the user of mobile handset 11. As such, the authentication indicator may be transferred to financial institution 16 to grant access to account 19. Alternatively, the authentication indicator may include the user's biometric information which may be transferred to authentication processor 14 for additional authentication.

In one embodiment, mobile handset 11 may be configured to directly generate an authentication code. For example, a user may enter an authentication code using the keypad 37 of mobile handset 11. Mobile handset 11 may thereby transfer the entered authentication code to authentication processor 14 for authentication of the user of mobile handset 11, as described hereinabove. Alternatively, the user may enter an authentication code from which code generator 32 encodes prior to transfer to authentication processor 14.

To assist in performing various transactions, mobile handset 11 may be configured with menu 33. Menu 33 may be displayed with display unit 32 of mobile handset 11. For example, mobile handset 11 may be configured with software components which the mobile handset processes to display menu 33 with display unit 32. Menu 33 may include information such as a transaction identification number, the user's financial institution(s), the user's credit account(s), chronological listing of past transactions, balance information within an account, etc. This information may be only available to a user of mobile handset 11 upon the user's authentication. For example, once authentication processor 14 authenticates the user and indicates such to financial institution 16, the financial institution may transfer account information to mobile handset 11 for selectable display with display unit 32.

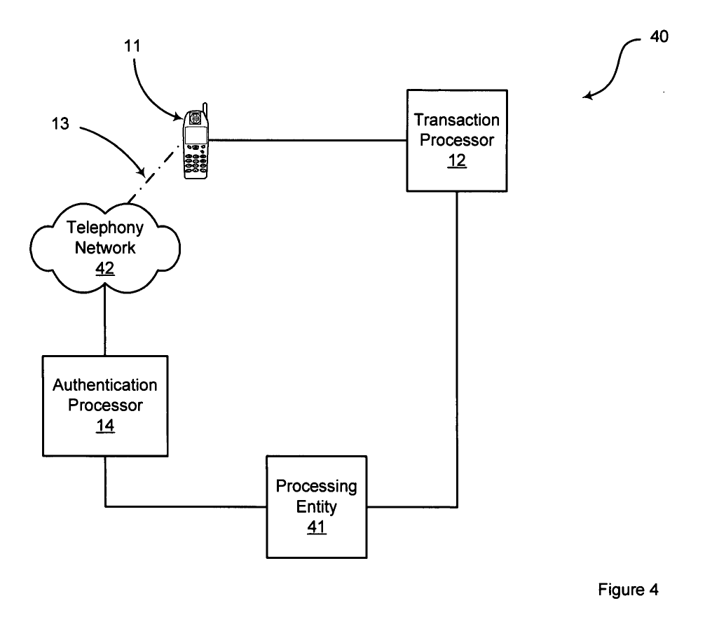

FIG. 4 is a block diagram of system 40 operable to perform transactions. In this embodiment, mobile handset 11 is configured for communicatively coupling to transaction processor 12 to receive a transaction description from transaction processor 12. The transaction description may indicate an exchange of property and/or services between the user of mobile handset 11 and transaction processor 12. For example, transaction processor 12 may be communicatively coupled to processing entity 41 to direct processing entity 41 to release property to the user of mobile handset 11 upon authentication of the user. In such an embodiment, processing entity 41 may operate as an escrow entity that holds property for another. Alternatively, processing entity 41 may operate as a personnel processor. For example, processing entity 41 may be a jail or some other form of detention center that necessitates authentication of an escort before personnel can be handed over to the escort.

Mobile handset 11 may communicate to authentication processor 14 via RF telephony techniques such as those described hereinabove to communicate through a telephony network. Mobile handset 11 may transfer or various authentication information as described hereinabove to authentication processor 14 for authentication of the user of mobile handset 11. Once authentication processor 14 authenticates the user, the authentication processor may indicate such to processing entity 41 for processing a transaction between the user of mobile handset 11 and transaction processor 12. Processing entity 41 may receive an authentication indicator as well as the transaction description from authentication processor 14 and process the transaction of the transaction description based on the authentication indicator.

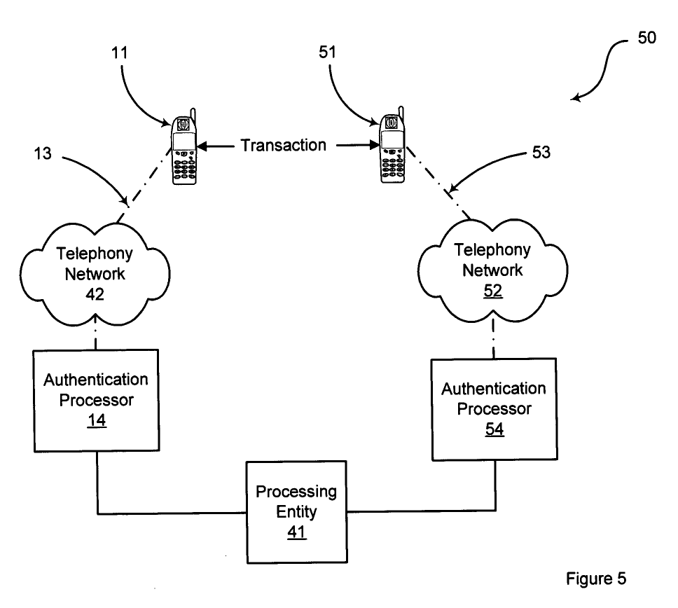

FIG. 5 is a block diagram of system 50 operable to perform transactions. In this embodiment, a transaction is performed between two mobile handsets (i.e., mobile handset 11 and mobile handset 51). For example, mobile handset 51 may convey a transaction description to mobile handset 11. Such conveyance may be performed in a variety of manners subject to design choice that include for example wireline couplings (e.g., serial cable, FireWire, etc.), infrared communications, optical communications, or RF communications. Mobile handset 11 initiates authentication of a user of the mobile handset such that the transaction of the transaction description may be performed.

Authentication of the user may be performed using mobile handset 11 and/or authentication processor 14 as described hereinabove. Once the user is authenticated, mobile handset 11 may transfer the transaction description to processing entity 41 (i.e., via telephony network 42 and authentication processor 14) to perform the transaction. For example, processing entity 41 may be configured to receive transaction information from mobile handset 11 and process the transaction information to perform a transaction between the users of mobile handset 11 and mobile handset 51.

Similar to the authentication of mobile handset 11, mobile handset 51 may also communicate to an authentication processor to authenticate the user of mobile handset 51. For example, mobile handset 51 may operate in a manner similar to that of mobile handset 11 as described in FIG. 3. In doing so, mobile handset 51 may communicate to authentication processor 54 via telephony network 52 by, for example, transferring an authentication code to authentication processor 54. Authentication processor 54 may then compare the authentication code to one or more authentication codes stored therewith. Once the user of mobile handset 51 is authenticated by authentication processor 54, the authentication processor may transfer an authentication indicator to processing entity 41 to enable processing of the transaction between mobile handset 11 and mobile handset 51.

Although mobile handset 51 is described with respect to generating a code, those skilled in the art should readily recognize that system 50 may be implemented with any of the embodiments described hereinabove or their combinations. For example, mobile handset 11 may be configured to sense a user's biometric and generate a code to authenticate the user via authentication processor 14 while mobile handset 51 is configured to allow a user to enter an authentication code via a keypad of mobile handset 51 for authentication of its user via authentication processor 54. Additionally, the transaction information may be transferred from mobile handset 11 to mobile handset 51.

Accordingly, system 50 is not intended to be limited to any one particular embodiment described herein.

Additionally, processing entity 41 may be configured from a general-purpose computer that connects to authentication processors 14 and 54 using standard communication techniques, such as the Internet. Accordingly, processing entity 41 may process software instructions operable to perform transactions between mobile handset 11 and mobile handset 51, regardless of the manner in which authentication of their respective users is achieved. For example, regardless of the manner in which authentication processor 14 and authentication processor 54 authenticates their respective users, each authentication processor may transfer and authentication indicator to processing entity 41. Processing entity 41 may compare the authentication indicators to one another, or to other authentication indicators, to validate a transaction between the users of the two mobile handsets.

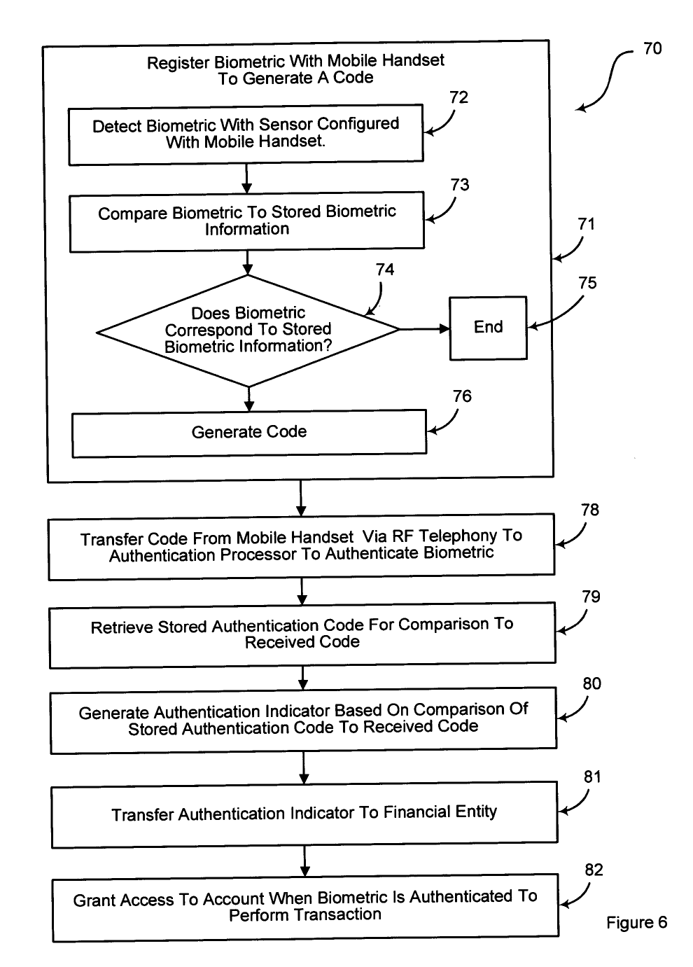

FIG. 6 is a flowchart illustrating process 70 for performing transactions. In this embodiment, process 70 initiates once a user registers a biometric with a mobile handset to generate an authentication code, in process element 71. For example, a user of mobile handset 11 may scan a biometric (e.g., a fingerprint) across a sensor (e.g., sensor 35 of FIG. 3) configured with the mobile handset, in process element 72. The sensor may detect the user's biometric for comparison to biometric information stored with the mobile handset, in process element 73. A determination may then be made as to whether the biometric corresponds to the stored biometric information, in process element 74. If the biometric does correspond to the stored biometric information, the mobile handset may generate an authentication code, in process element 76. If, however, the biometric does not correspond to the stored biometric information, process 70 may end in process element 75, potentially requiring a user of the mobile handset to reenter the biometric.

If mobile handset 11 generates an authentication code in process element 76, mobile handset 11 may transfer the authentication code to an authentication processor, such as authentication processor 14 described hereinabove. Mobile handset 11 may transfer the authentication code to the authentication processor via RF telephony, in process element 78. Once the authentication processor receives the authentication code, the authentication processor may retrieve one or more authentication codes from storage for comparison to the received authentication code, in process element 79.

Process 70 may generate an authentication indicator based on a comparison of the stored authentication code to the received authentication code, in process element 80. For example, the authentication processor may include a comparator that is used to compare one or more authentication codes stored within the storage element of the authentication processor. A comparator may compare these one or more authentication codes to the received authentication code to determine if the received authentication code corresponds to one of the stored authentication codes. A plurality of the authentication codes may be used for synchronization purposes, as described hereinabove as well as in the '375 application. If the received authentication code matches one of the stored authentication codes, the authentication processor may generate an authentication indicator.

Authentication indicator may be used to indicate the authenticity of a user of the mobile handset. For example, a financial entity may use the authentication indicator to verify that the user of a mobile handset has been authenticated. A financial entity may therefore grant access to the user's account such that the user may perform a transaction. As such, the authentication processor may transfer the authentication indicator to a financial entity, such as financial institution 16 of FIG. 1, in process element 81. Additionally, a financial entity may grant access to the user's account when the biometric is authenticated, in process element 82.

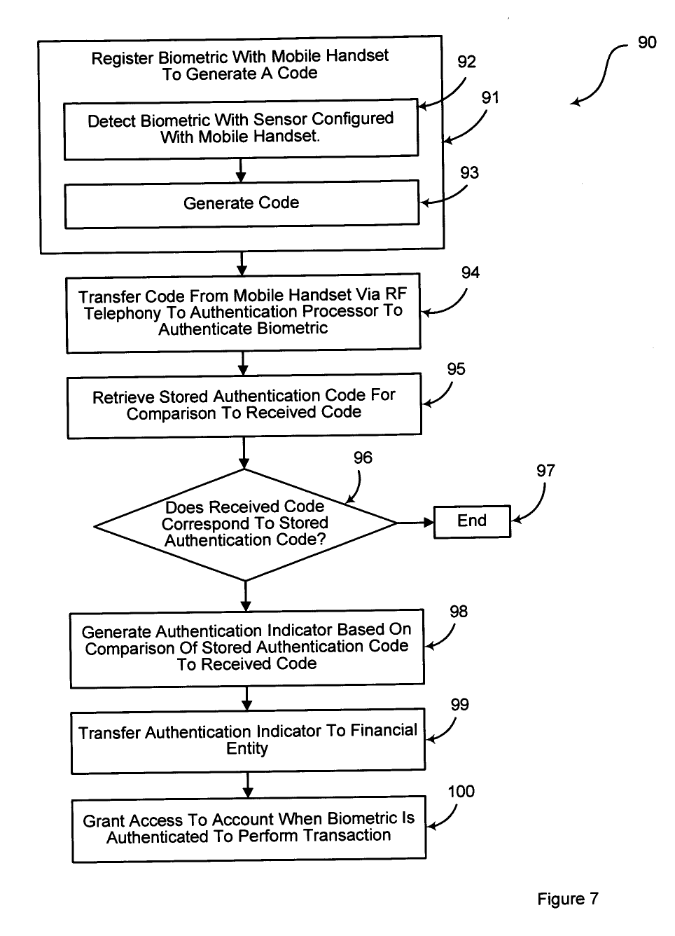

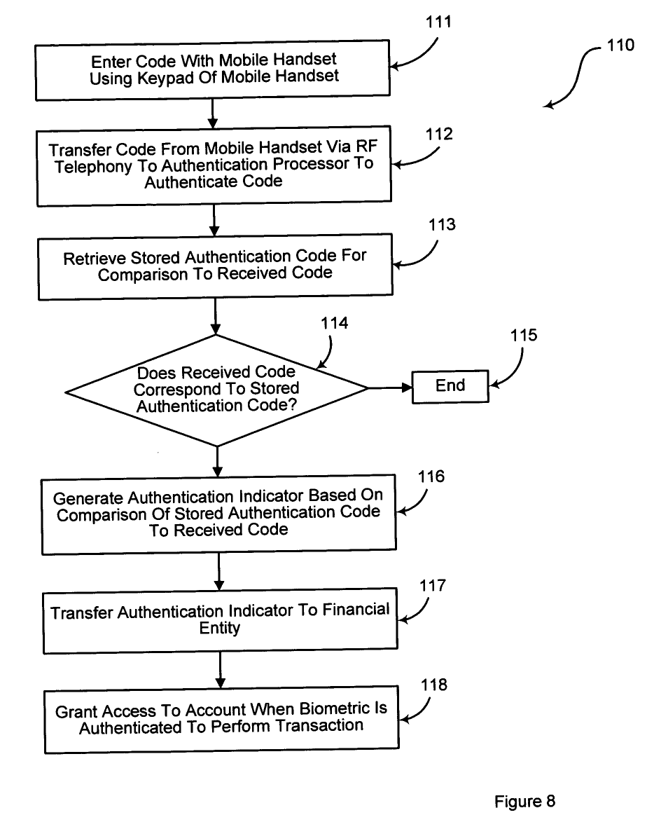

Although described with respect to registering a biometric with the mobile handset and having the mobile handset generate a code used for authentication of the user by an authentication processor, those skilled in the art should readily recognize that the invention is not intended to be limited to such an exemplary embodiment. For example, other embodiments, such as those described below in FIGS. 7 and 8, may implement authentication in other manners that are typically subject to design choice. To illustrate, code generation as described in process element 76 may be obviated should design specifications require authentication only through the detection of the user's biometric and subsequent comparison to biometric information stored within the mobile handset. In such an embodiment, a simple authentication indicator may be generated and transferred from the mobile handset directly to the financial entity to grant access to the user's account. Accordingly, such embodiments may also fall within the scope and spirit of the invention.

FIG. 7 is a flowchart illustrating process 90 for performing transactions. In this embodiment, a user of a mobile handset (e.g., mobile handset 11) may register a biometric with the mobile handset to generate a code, in process element 91. For example, a user of mobile handset 11 may scan a biometric (e.g., a fingerprint) across a sensor (e.g., sensor 35 of FIG. 3) configured with the mobile handset. The sensor may detect the user's biometric in process element 91 and generate a code therefrom in process element 93.

The generated code may be transferred from the mobile handset via RF telephony to an authentication processor to authenticate the biometric of the user, in process element 94. The code that is generated may be configured in a variety of manners that include a phone number associated with a mobile handset, a serial number of the mobile handset, digital biometric information of the user, and/or various encryption techniques, such as the AES. The authentication processor may retrieve one or more stored authentication codes, in process element 95, for comparison to the received code as generated by the mobile handset. For example, the authentication processor may compare the received code to one or more stored authentication codes to determine whether the two codes correspond to one another, in process element 96. If the codes do not correspond, the user is not authenticated and process 90 ends in process element 97. If, however, the two codes do correspond, the authentication processor may generate an authentication indicator based on the comparison of the two codes, in process element 98.

Once the authentication indicator is generated, the authentication processor may transfer the authentication indicator to a financial entity or other processing entity, in process element 99. The financial entity may grant access to a user's account when the biometric is authenticated to perform the transaction, in process element 100. For example, the financial entity may process the authentication indicator to determine that the user's biometric has been authenticated. As such, the financial entity may determine that the user may be granted access to the user's account to perform a transaction between the mobile handset and, e.g., a transaction processor such as transaction processor 12 of FIG. 4.

FIG. 8 is a flowchart illustrating process 110 for performing transactions. In this embodiment, a user of a mobile handset may enter a code with the mobile handset using a keypad configured therewith, in process element 111. For example, the user may enter a series of numbers using the keypad of the mobile handset. The mobile handset may transfer the entered series of numbers to an authentication processor, such as authentication processor 14 described hereinabove, in process element 112.

The authentication processor may retrieve one or more stored authentication codes for comparison to the received code, in process element 113. The authentication processor may then compare the received code to the one or more stored authentication codes to determine whether the received code corresponds to one of the stored authentication codes, in process element 114. If the received code does not correspond to one of the stored authentication codes, process 110 ends in process element 115. If, however, the received code does correspond to one of the authentication codes, the authentication processor may generate an authentication indicator, in process element 116.

The authentication processor may transfer the authentication indicator to a financial entity, such as financial institution 16 of FIG. 1, or some other processing entity, such as processing entity 41 of FIG. 4, in process element 117. Based on that authentication indicator, the financial entity may grant access to a user's account because the user's identity has been authenticated, in process element 118. As such, the user may perform the transaction.

Although discussed with respect to entering a code with the keypad of a mobile handset and transferring that code to an authentication processor, the invention is not intended to be limited to such an embodiment. For example, a user may enter a first code into the mobile handset for the mobile handset to authenticate a user. The mobile handset may subsequently generate a second code for transfer to the authentication processor. Generating a second code may include encrypting the first code or even generating a completely unique second code in response to the authenticated first code. Such generation of a second code may prove advantageous because, among other reasons, the first code may be more securely transferred to the authentication processor or even the processing entity, thereby minimizing the exposure of the first code to unintended viewers. Accordingly, the invention is not intended to be limited to the exemplary embodiment shown and described herein.

While the invention has been illustrated and described in detail in the drawings and foregoing description, such illustration and description is to be considered as exemplary and not restrictive in character. Accordingly, it should be understood that only the preferred embodiment and minor variants thereof have been shown and described and that all changes and modifications that come within the spirit of the invention are desired to be protected.

1. A system that performs a transaction, including:
a mobile handset that includes a biometric sensor, wherein the biometric sensor detects a biometric from a user of the mobile handset and wherein the mobile handset is associated with an account number; and
an authentication processor configured to receive an authentication code from the mobile handset, wherein the authentication processor uses the authentication code to authenticate the user and wherein the user is granted access to an account corresponding to the account number when the user is authenticated by the authentication processor.

2. The system of claim 1, wherein the account number is a phone number.

3. (canceled)

4. (canceled)

5. (canceled)

6. The system of claim 1, wherein the mobile handset includes a storage element that stores biometric information of the user for comparison to a detected said biometric.

7. The system of claim 6, wherein the mobile handset further includes a comparator that compares stored said biometric information to the detected said biometric to generate an authentication indicator.

8. (canceled)

9. The system of claim 1, wherein the authentication processor includes an interface that receives the authentication code from the mobile handset and;
a comparator that compares a received said authentication code to a stored authentication code to authenticate the user.

10. (canceled)

11. (canceled)

12. The system of claim 9, wherein the authentication processor further includes an authenticator communicatively coupled to the comparator to generate an authentication indicator when the user is authenticated by the comparator.

13. (canceled)

14. The system of claim 1, further including a first processing entity communicatively coupled to the authentication processor to grant access to the account when the user is authenticated by the authentication processor.

15. The system of claim 14, further including a second processing entity communicatively coupled to the first processing entity, wherein the first processing entity transfers money from the account to the second processing entity to perform the transaction for the user.

16. The system of claim 15, further including a transaction processor communicatively coupled to the mobile handset to transfer transaction information to the mobile handset.

17. The system of claim 16, wherein the transaction processor is communicatively coupled to the second processing entity, wherein the second processing entity transfers a transaction indicator to the transaction processor to indicate transaction performance.

18. (canceled)

19. (canceled)

20. A method of performing a transaction, including:
registering a biometric with a mobile handset to generate a code;
transferring the code from the mobile handset to an authentication processor to authenticate the biometric; and
granting access to an account when the biometric is authenticated to perform a transaction.

21. The method of claim 20, wherein registering a biometric includes:
detecting the biometric with a sensor configured with the mobile handset.

22. (canceled)

23. (canceled)

24. (canceled)

25. (canceled)

26. (canceled)

27. The method of claim 20, further including:
generating an authentication indicator based on the comparison of the code to a stored authentication code; and
transferring the authentication indicator to a financial entity.

28. The method of claim 27, wherein granting access to an account includes:
granting said access to said account based on the authentication indicator.

29. (canceled)

30. (canceled)

31. (canceled)

32. (canceled)

33. (canceled)

34. (canceled)

35. (canceled)

36. A mobile telephony handset, including:
a transceiver that communicatively links via a phone number;
a sensor that receives first biometric information; and
a processor that processes the first biometric information to perform a transaction using the phone number.

37. The mobile telephony handset of claim 36, further including a storage element that stores second biometric information.

38. (canceled)

39. (canceled)

40. (canceled)

41. The mobile telephony handset of claim 36, wherein the transaction is a monetary transaction, a property transaction, a personnel transaction, or a combination thereof.

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. A method of performing a transaction, including steps of:
registering a biometric with a portable communication device to convert the biometric to electronic biometric information; and
with the portable communication device,
processing the electronic biometric information to authenticate a user, and
generating authentication information for a transaction when the user is authenticated.

54. The method of claim 53, wherein the step of registering a biometric includes a step of:
providing the biometric to an electronic sensor, wherein the biometric is selected from a group consisting of DNA, a follicle pattern, an veinal pattern, an arterial pattern, a cardio pattern, a fingerprint, a voice pattern, an aural pattern, a retinal pattern, a corneal pattern, and a skin pattern.

55. (canceled)

56. The method of claim 53, wherein processing the electronic biometric information includes a step of:
comparing the electronic biometric information to biometric information stored with the portable communication device to determine whether the electronic biometric information corresponds to the biometric information stored with the portable communication device.

57. The method of claim 56, wherein processing the electronic biometric information further includes a step of:
generating a first indicator when the electronic biometric information corresponds to the biometric information stored with the portable communication device.

58. The method of claim 57, wherein the step of generating authentication information includes a step of:
formatting a phone number within the authentication information based on the first indicator.

59. The method of claim 58, wherein the authentication information is devoid of the electronic biometric information and the biometric information stored with the portable communication device.

60. The method of claim 56, wherein processing the electronic biometric information further includes a step of:
generating a second indicator when the electronic biometric information does not correspond to the biometric information stored with the portable communication device.

61. The method of claim 60, further including a step of:
using the second indicator to deny the transaction.

62. The method of claim 53, further including a step of:
transferring the authentication information to a transaction processor for authorization of the transaction.

63. (canceled)

64. The method of claim 53, wherein the transaction is a financial transaction, a property transaction, a personnel transaction, or a combination thereof.

65. The method of claim 53, wherein the portable communication device is a cellular telephone.

66. (canceled)

67. (canceled)

68. (canceled)

69. (canceled)

70. (canceled)

71. (canceled)

72. (canceled)

73. (canceled)

74. (canceled)
